(19) United States
(12) Patent Application Publication
(10) Pub. No.: US 2026/0138393 A1
(43) Pub. Date: May 21, 2026

(54) WEAR RESISTANT WHEEL AND BRAKE COMPONENTS

(71) Applicant: Goodrich Corporation, Charlotte, NC (US)

(72) Inventors: Lei Chen, South Windsor, CT (US); Brian T Brandewie, Anna, OH (US); Michael Miller, Glastonbury, CT (US); Blair A Smith, Manchester, CT (US)

(73) Assignee: Goodrich Corporation, Charlotte, NC (US)

(21) Appl. No.: 18/953,507

(22) Filed: Nov. 20, 2024

(51) Int. Cl. B60B 21/12; B64C 25/34

(52) U.S. Cl. CPC B60B 21/12; B64C 25/34; B60B 2310/621; B60B 2360/70; B60B 2900/141

(57) ABSTRACT

An aircraft component is disclosed. The aircraft component includes a substrate, the substrate comprising at least one a first metal or first metal alloy and a ceramic coating formed on a surface of at least a portion of the substrate. The ceramic coating is formed by applying a cold sprayed material to the surface, the cold sprayed material being at least one of a second metal or second metal alloy that meets a predetermined galvanic compatibility with the first metal or the first metal alloy and subjecting the aircraft component to a plasma electrolytic oxidation (PEO) process, wherein during the PEO process the cold sprayed material on the surface is converted to ceramic.

### FIELD

The present disclosure generally relates to the field of aircraft and, more particularly, to wear resistant wheel and brake components of the aircraft.

### BACKGROUND

Typical aircrafts include landing gear for supporting the aircraft above a ground surface and for allowing the aircraft to move relative to the ground surface while remaining supported by the ground surface. Each landing gear may include one or more wheel assemblies that may each receive an aircraft tire and one or more brake assemblies that are configured to slow and/or stop the one or more wheel assemblies.

### SUMMARY

According to various embodiments of the present disclosure, an aircraft component is provided. The aircraft component includes a substrate and a ceramic coating formed on a surface of at least a portion of the substrate. The substrate includes at least one a first metal or a first metal alloy. The ceramic coating is formed on the surface of the at least the portion of the substrate by applying a at least one of a second metal or a second metal alloy to the at least the portion of the substrate, the at least one of the second metal or the second metal alloy meeting a predetermined galvanic compatibility with the at least one of the first metal or the first metal alloy; and subjecting the aircraft component to a plasma electrolytic oxidation (PEO) process, wherein during the PEO process the at least one of the second metal or the second metal alloy on the surface of the at least the portion of the substrate is converted to ceramic.

In various embodiments, the portion of the substrate includes at least one of a localized repair area or an entire surface of the aircraft component.

In various embodiments, the aircraft component is at least one of a new component or dimensionally restored component.

In various embodiments, prior to applying the cold sprayed material to the surface of the aircraft component, the aircraft component is cleaned and prepared for optimal adhesion of the at least one of the second metal or the second metal alloy to the surface.

In various embodiments, prior to subjecting the aircraft component to the PEO process, the aircraft component with the at least one of the second metal or the second metal alloy is cleaned.

In various embodiments, cleaning the aircraft component with the at least one of the second metal or the second metal alloy includes machining the at least one of the second metal or the second metal alloy the surface of the at least the portion of the substrate to a desired surface finishing. In various embodiments, the at least the portion of the substrate is a dimensionally restored portion of the aircraft component.

In various embodiments, the first metal or the first metal alloy is at least one of first aluminum, a first aluminum alloy, first magnesium, a first magnesium alloy, first titanium, or a first titanium alloy. In various embodiments, the second metal or the second metal alloy is at least one of second aluminum, a second aluminum alloy, second magnesium, a second magnesium alloy, second titanium, or a second titanium alloy.

In various embodiments, after subjecting the aircraft component to the PEO process, at least one of a sealant that penetrates and fills pores within the ceramic coating is applied or the ceramic coating is impregnated with the sealant.

Also, a landing gear system of an aircraft is disclosed herein. The landing gear system of an aircraft includes at least one aircraft component. The at least one aircraft component includes a substrate and a ceramic coating formed on a surface of at least a portion of the substrate. The substrate includes at least one a first metal or first metal alloy. The ceramic coating is formed by applying at least one of a second metal or a second metal alloy to the surface of the at least the portion of the substrate, the at least one of the second metal or the second metal alloy meeting a predetermined galvanic compatibility with the at least one of the first metal or the first metal alloy; and subjecting the aircraft component to a plasma electrolytic oxidation (PEO) process, wherein during the PEO process the at least one of the second metal or the second metal alloy on the surface of the at least the portion of the substrate is converted to ceramic.

In various embodiments, the portion of the substrate includes at least one of a localized repair area or an entire surface of the aircraft component.

In various embodiments, the aircraft component is at least one of a new component or dimensionally restored component.

In various embodiments, prior to applying the at least one of the second metal or the second metal alloy to the surface of the at least the portion of the substrate, the aircraft component is cleaned and prepared for optimal adhesion of the at least one of the second metal or the second metal alloy to the surface.

In various embodiments, prior to subjecting the aircraft component to the PEO process, the aircraft component with the at least one of the second metal or the second metal alloy is cleaned. In various embodiments, cleaning the aircraft component with the at least one of the second metal or the second metal alloy includes machining the at least one of the second metal or the second metal alloy the surface of the at least the portion of the substrate to a desired surface finishing. In various embodiments, the at least the portion of the substrate is a dimensionally restored portion of the aircraft component.

In various embodiments, the first metal or the first metal alloy is at least one of first aluminum, a first aluminum alloy, first magnesium, a first magnesium alloy, first titanium, or a first titanium alloy. In various embodiments, the second metal or the second metal alloy is at least one of second aluminum, a second aluminum alloy, second magnesium, a second magnesium alloy, second titanium, or a second titanium alloy.

Additionally, an aircraft is disclosed herein. The aircraft includes a landing gear. The landing gear includes an aircraft component. The aircraft component includes a substrate and a ceramic coating formed on a surface of at least a portion of the substrate. The substrate includes at least one a first metal or first metal alloy The ceramic coating is formed by applying a at least one of a second metal or a second metal alloy to the surface of the at least the portion of the substrate, the at least one of a second metal or second metal alloy meeting a predetermined galvanic compatibility with the at least one of the first metal or the first metal alloy; and subjecting the aircraft component to a plasma electrolytic oxidation (PEO) process, wherein during the PEO process the at least one of the second metal or the second metal alloy on the surface of the at least the portion of the substrate is converted to ceramic.

In various embodiments, the portion of the substrate includes at least one of a localized repair area or an entire surface of the aircraft component.

In various embodiments, the aircraft component is at least one a new component or dimensionally restored component.

In various embodiments, prior to applying the at least one of the second metal or the second metal alloy to the surface of the at least the portion of the substrate, the aircraft component is cleaned and prepared for optimal adhesion of the at least one of the second metal or the second metal alloy to the surface.

In various embodiments, prior to subjecting the aircraft component to the PEO process, the aircraft component with the at least one of the second metal or the second metal alloy is cleaned. In various embodiments, cleaning the aircraft component with the at least one of the second metal or the second metal alloy includes machining the at least one of the second metal or the second metal alloy the surface of the at least the portion of the substrate to a desired surface finishing. In various embodiments, the at least the portion of the substrate is a dimensionally restored portion of the aircraft component.

In various embodiments, the first metal or the first metal alloy is at least one of first aluminum, a first aluminum alloy, first magnesium, a first magnesium alloy, first titanium, or a first titanium alloy. In various embodiments, the second metal or the second metal alloy is at least one of second aluminum, a second aluminum alloy, second magnesium, a second magnesium alloy, second titanium, or a second titanium alloy.

The present disclosure may include any one or more of the individual features disclosed above and/or below alone or in any combination thereof.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an aircraft including multiple landing gear systems, in accordance with various embodiments.

FIG. 2 illustrates a wheel assembly that includes a split wheel including of a first wheel portion and a second wheel portion, in accordance with various embodiments.

FIG. 3 illustrates a schematic depiction of a brake assembly that may be used by an aircraft, in accordance with various embodiments.

FIG. 4 illustrates a method for converting a surface of an aircraft component to include a hard ceramic coating, according to various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values and all ranges and ratio limits disclosed herein may be combined.

Typical aircrafts include landing gear for supporting the aircraft above a ground surface and for allowing the aircraft to move relative to the ground surface while remaining supported by the ground surface. Each landing gear may include one or more wheel assemblies that may each receive an aircraft tire and one or more brake assemblies that are configured to slow and/or stop the one or more wheel assemblies. Many of the components within the one or more wheel assemblies, the one or more brake assemblies, as well as other assemblies within the aircraft, such as drive lugs or torque bars, among others, are subject to fretting wear or abrasive wear, among others. The wear damages will eventually necessitate either repair for reuse or lead to rejection of the worn components beyond certain prescribed limits. To extend the serviceable life of such components, it may be beneficial to harden the surface of either a new or dimensionally restored component. Metal or metal alloy surfaces converted by a plasma electrolytic oxidation (PEO) process may achieve improved wear resistance and extend component serviceable life.

Therefore, disclosed herein are methods and systems to convert the surface of various aircraft components, such as wheel assembly components or brake assembly components, to include a hard ceramic coating via a room temperature PEO process. In various embodiments, the aircraft component is a new or dimensionally restored wheel component or brake component, among others. In various embodiments, the new or the dimensionally restored wheel component or brake component, among others, may be at least one first metal or first metal alloy component and may be comprised of aluminum, magnesium, titanium, an aluminum alloy, a magnesium alloy, or a titanium alloy, among others. In various embodiments, the aluminum may be 2014 aluminum alloy (AA 2014). 2014 aluminum alloy is identified is identified per AMS 4133. Other optional aluminum alloys may include 7050 per AMS 4107. In various embodiments, responsive to receiving a component, i.e., the new or the dimensionally restored wheel component or brake component, among others, the component is cleaned in order to receive at least one of a second metal or a second metal alloy deposition. In various embodiments, if the component is a dimensionally restored component, then only the dimensionally restored portion of the component may be coated. In that regard, in various embodiments, one or more portions of the component, i.e., a localized repair area, may be masked so as to receive the coating only on the desired portion. In that regard, the component may be mechanically masked in order to coat the surface of the portion of the component that is subject to fretting wear or abrasive wear, among others. However, in various embodiments, the entire component may be coated with a coating thickness between 12 μm and 50 μm to ensure acceptable fatigue capability. In various embodiments, once the component is ready to receive the at least one of the second metal or the second metal alloy deposition, the at least one of the second metal or the second metal alloy deposition may be applied to the entire component or a portion of the component, i.e., the masked off portion of the component. In various embodiments, the at least one of the second metal or the second metal alloy deposition may be applied via cold spaying, metallic plating, or friction stirring, among others.

Cold spray is a process technology that enables the rapid deposition of a wide range of metals and some other materials in the solid state at temperatures far below their melting points. Compared to common thermal spray coating methods, some potential advantages of cold spray include less substrate heating, compressive residual stresses in the spray-deposited material (which enables very thick deposits, ranging up to many centimeters), no heat-related chemistry or phase changes in the sprayed material, and, in most cases, little or no oxidation of the deposited material, even when sprayed in an ambient air environment. Friction stirring is a process where a rotating tool with a single piece of material traverses along the desired line to cover the region of interest. Friction between the tool and workpieces results in localized heating that softens and plasticizes the workpiece. A volume of processed material is produced by movement of materials. During this process, the material undergoes intense plastic deformation, which results in significant grain refinement. Mechanical plating is a process that is a form of ‘cold welding’ in which a coating is applied using kinetic energy at room temperature without any lasting hydrogen embrittlement. Coating bond development is caused by the deformation of metal spheroids that expose clean active surfaces, allowing the particles to be cold welded into an atomic bond. Accordingly, in various embodiments, the at least one second metal or second metal alloy may be comprised of aluminum, magnesium, titanium, an aluminum alloy, a magnesium alloy, or a titanium alloy, among others.

It is noted that the illustrative embodiments are not limited to applying aluminum or an aluminum alloy to an aluminum or aluminum alloy component, titanium or a titanium alloy to a titanium or titanium alloy component, or magnesium or a magnesium alloy to a magnesium or a magnesium alloy component. That is, in various embodiments, as long as predetermined galvanic compatibility between the at least one second metal or second metal alloy and the at least one first metal or first metal alloy of the component is met, a first type of the at least one second metal or second metal alloy may be applied to a second type of the at least one first metal or first metal alloy component, such as, for example, an aluminum alloy-may be applied to a titanium/titanium alloy-based component. In various embodiments, once the at least one second metal or second metal alloy is applied, then the component is cleaned again in preparation for the PEO process in order to convert the at least one second metal or second metal alloy material into a ceramic material. In that regard, in various embodiments, the component is cleaned and prepared for optimal adhesion of the at least one of the second metal or the second metal alloy to the surface. Non-acidic cleaning process is preferred to minimize potential impact on fatigue capability. In various embodiments, either prior to or after the second cleaning, a surface of the component may be machined to provide a surface suitable for the PEO process in order for a desired ceramic coating may be generated on the surface of the component. In various embodiments, once the component is cleaned with or without machining, the component undergoes a PEO process to sufficiently form a ceramic coating that is wear resistant on the surface of the component that is wear resistant. In various embodiments, all of the at least one second metal or second metal alloy material is converted into the ceramic material via the PEO process. In various embodiments, only a finite thickness, i.e., an outermost portion, of the at least one second metal or second metal alloy material is converted into the ceramic material via the PEO process. Finally, in various embodiments, the component may be sealed with a sealant that penetrates and fills pores the ceramic coating or may be impregnated with the sealant, i.e., active corrosion inhibitors to protect the substrate of the component from corrosion. In various embodiments, the sealant may be an epoxy-based sealant or a polymer-based sealant, among others.

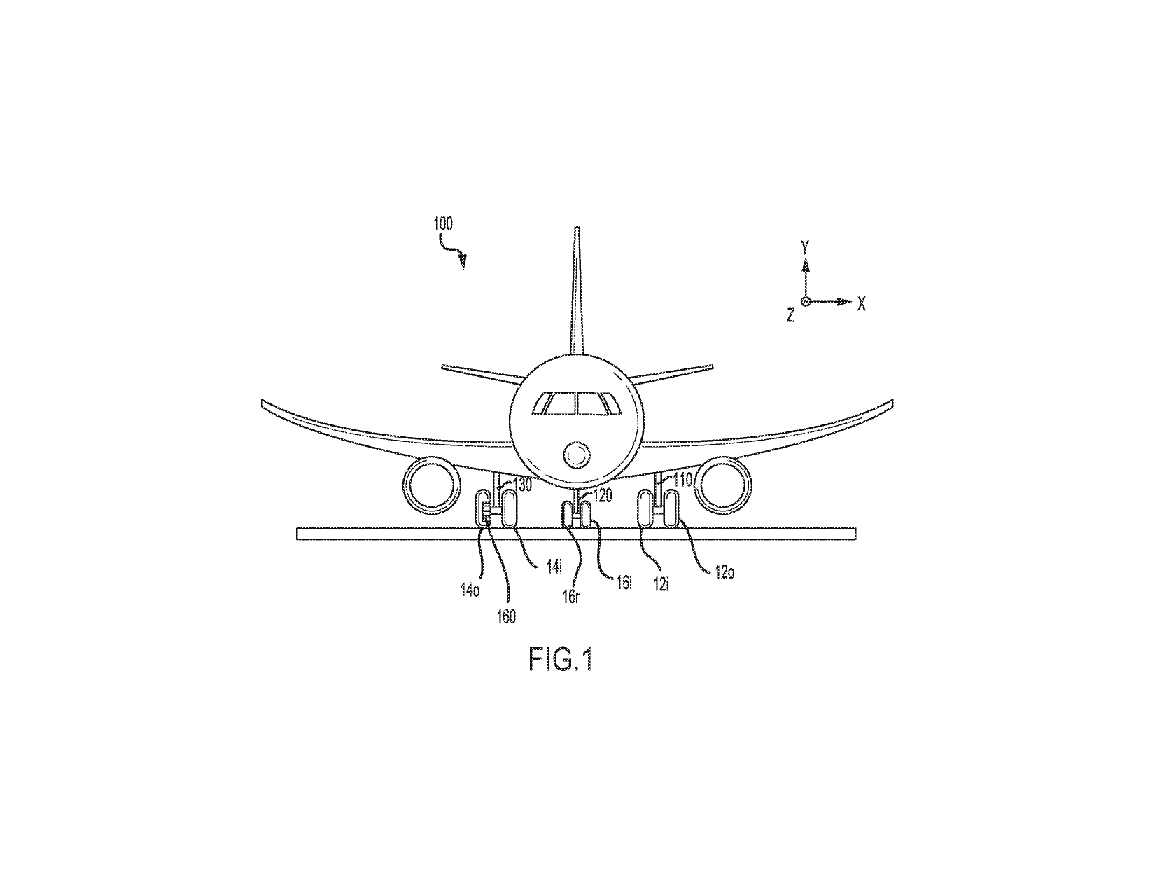

Referring now to FIG. 1, in accordance with various embodiments, an aircraft 100 including multiple landing gear systems, i.e., a first landing gear 110, a second landing gear 120, and a third landing gear 130, is illustrated. The first landing gear 110, second landing gear 120, and third landing gear 130 each include one or more wheel assemblies. In various embodiments, the second landing gear 120, which is also a nose landing gear for the aircraft 100, includes a left wheel assembly 16l and a right wheel assembly 16r. In various embodiments, the first landing gear 110 includes an inboard wheel assembly 12i and an outer wheel assembly 12o, and the third landing gear 130 includes an inner wheel assembly 14i and an outer wheel assembly 14o. The first landing gear 110, second landing gear 120, and third landing gear 130 support the aircraft 100 when the aircraft 100 is not flying, thereby allowing the aircraft 100 to take off, land, and taxi without damaging the aircraft 100. In various embodiments, the second landing gear 120 is also a nose landing gear for the aircraft 100, and often times, one or more of the first landing gear 110, second landing gear 120, and third landing gear 130 are operationally retractable into the aircraft 100 when the aircraft 100 is in flight and/or airborne.

In various embodiments, the aircraft 100 further includes one or more brakes coupled to each wheel assembly. For example, a brake assembly 160 is coupled to the outer wheel assembly 14o of the third landing gear 130 of the aircraft 100. In operation, the brake assembly 160 applies a braking force to the outer wheel assembly 14o upon receiving a brake command. In various embodiments, the outer wheel assembly 14o of the third landing gear 130 of the aircraft 100 includes any number of wheels.

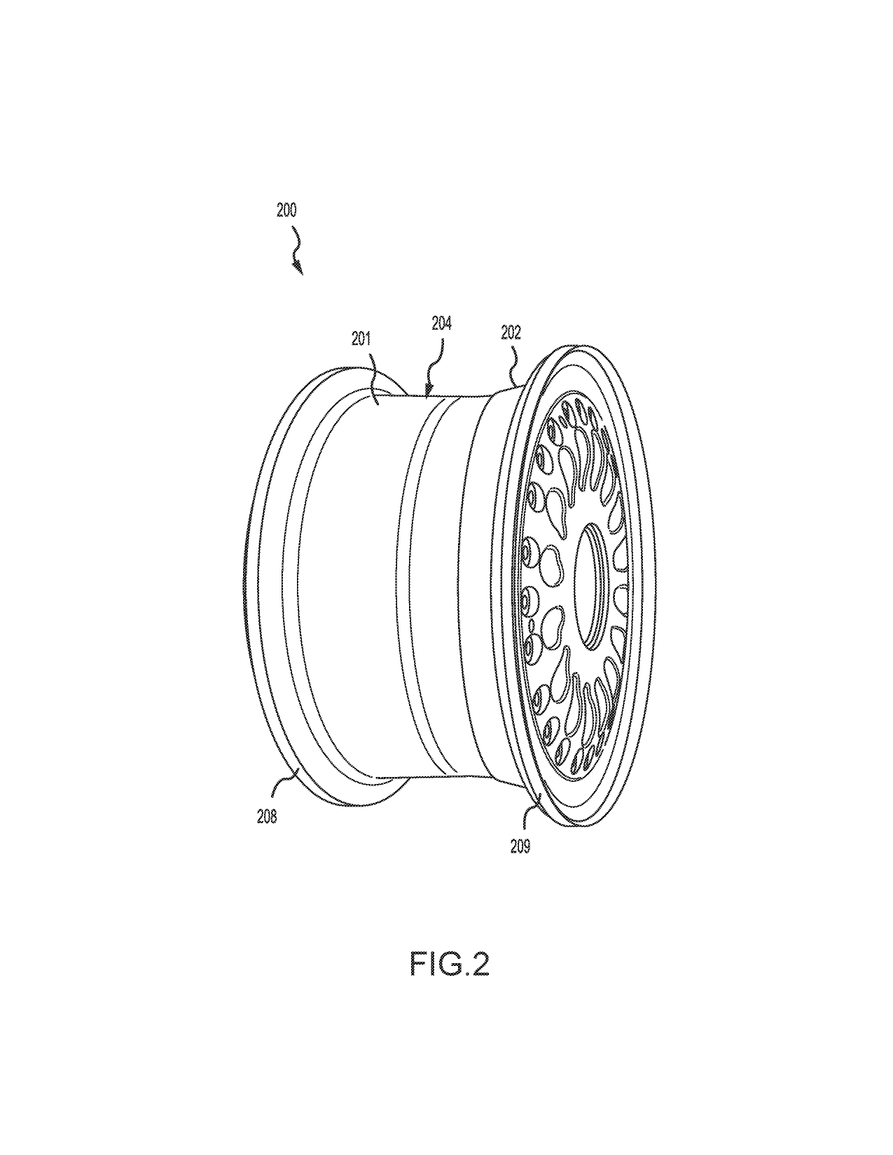

Referring now to FIG. 2, in accordance with various embodiments, a wheel assembly 200 that includes a split wheel including of a first wheel portion 201 and a second wheel portion 202 is illustrated. That is, wheel assembly 200 may include a split wheel having multiple wheel portions, such as an inboard wheel portion and an outboard wheel portion. Wheel portions 201, 202, for example, may be referred to as wheel halves (e.g., the first wheel portion 201 may be referred to as an inboard wheel half and the second wheel portion 202 may be referred to as an outboard wheel half). The wheel assembly 200 may be implemented with any landing gear of the aircraft 100 (e.g., any of the three landing gears mentioned above), and the wheel assembly 200 may be an inner/inboard wheel assembly or an outer/outboard assembly.

In various embodiments, wheel assembly 200 also defines a tube-well 204. Tube-well 204 may be defined by respective flange sections of the first wheel portion 201 and the second wheel portion 202. Tube-well 204 may be configured to receive a tire and may form a seal with tire to allow pressurized air to inflate the tire. In various embodiments, the first wheel portion 201 also includes a radially outward extending lip or rim 208 located at an inboard end of the first wheel portion 201, and the second wheel portion 202 may also include a similar radially outward extending lip or rim 209 located at an outboard end of the second wheel portion 202.

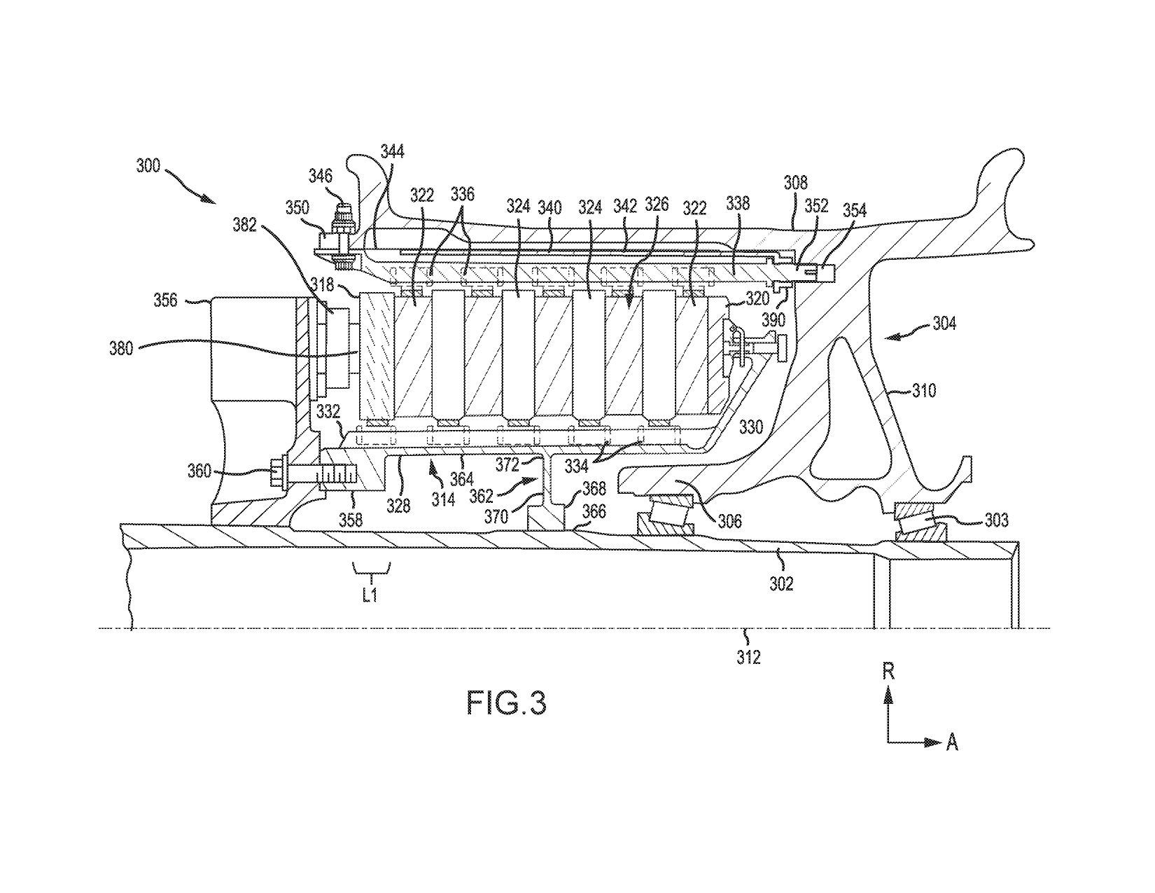

Referring now to FIG. 3, in accordance with various embodiments, a schematic depiction of a brake assembly 300 that may be used by an aircraft, such as aircraft 100 of FIG. 1, or any other appropriate aircraft, is illustrated. Brake assembly 300 may be an example of a brake assembly 160 described previously with respect to FIG. 1. Brake assembly 300 is mounted on an axle 302 for use with a wheel 304 disposed on and configured to rotate about axle 302 via one or more bearing assemblies 303. Wheel 304 includes a hub 306, a wheel well 308 concentric about hub 306 and a web portion 310 interconnecting the hub 306 and the wheel well 308. A central axis 312 extends through axle 302 and defines a center of rotation of wheel 304. A torque plate barrel 314 (sometimes referred to as a torque tube or barrel or a torque plate or back leg) is aligned concentrically with hub 306, and wheel 304 is rotatable relative to torque plate barrel 314.

Brake assembly 300 includes a set of hydraulic actuators (HAs), typically between 4 and 16, one of which is illustrated as HA 382, a pressure plate 318 disposed adjacent the HA 382, an end plate 320 positioned a distal location from the HA 382, and a plurality of rotor disks 322 interleaved with a plurality of stator disks 324 positioned intermediate to the pressure plate 318 and the end plate 320. Pressure plate 318, the plurality of rotor disks 322, the plurality of stator disks 324, and end plate 320 together form a brake heat sink or brake stack 326. Pressure plate 318, end plate 320, and the plurality of stator disks 324 are mounted to torque plate barrel 314 and remain rotationally stationary relative to axle 302.

Torque plate barrel 314 may include an annular barrel or torque tube 328 and an annular plate or back leg 330. Back leg 330 is disposed at an end distal from HA 382 and may be made monolithic with torque tube 328 or may be made as a separate annular piece and suitably connected to torque tube 328. Torque tube 328 has a plurality of circumferentially spaced and axially extending splines 332 disposed on an outer surface of the torque tube 328. The plurality of stator disks 324 and pressure plate 318 include notches or stator slots 334 on an inner periphery of the disks and the plate for engagement with splines 332, such that each disk and the plate are axially slidable with respect to torque tube 328.

End plate 320 is suitably connected to back leg 330 of torque plate barrel 314 and is held non-rotatable, together with the plurality of stator disks 324 and pressure plate 318, during a braking action. The plurality of rotor disks 322, interleaved between pressure plate 318, end plate 320, and the plurality of stator disks 324, each have a plurality of circumferentially spaced notches or rotor lugs 336 along an outer periphery of each disk for engagement with a plurality of torque bars 338 that are secured to or made monolithic with an inner periphery of wheel 304.

An actuating mechanism for the brake assembly 300 includes a plurality of HAs circumferentially spaced around an annular brake housing 356 (only one HA, HA 382, is illustrated in FIG. 3). Upon actuation, the plurality of HAs affects a braking action by urging the pressure plate 318 and the plurality of stator disks 324 into frictional engagement with the plurality of rotor disks 322 and against end plate 320. Each of the plurality of HAs (e.g., HA 382, etc.) includes a ram 380 configured to engage pressure plate 318 by extending a length, or distance, L1. An electric power is applied to the EHA to actuate the plurality of HAs, such as HA 382) causing ram 380 to extend and engage pressure plate 318. Through compression of the plurality of rotor disks 322 and the plurality of stator disks 324 between pressure plate 318 and end plate 320, the resulting frictional contact slows or stops or otherwise prevents rotation of wheel 304. The plurality of rotor disks 322 and the plurality of stator disks 324 are fabricated from various materials, such as carbon matrix composites, which enable the brake disks to withstand and dissipate the heat generated during and following a braking action.

Torque plate barrel 314 is secured to a stationary portion of the landing gear such as axle 302, preventing the torque plate barrel 314 and the plurality of stator disks 324 from rotating during braking of the aircraft. Torque tube 328 portion of torque plate barrel 314 may be attached to annular brake housing 356 via an annular mounting surface 358, where bolt fasteners 360 secure torque plate barrel 314 to annular brake housing 356. A spacer member or pedestal 362 is positioned between an inner diameter surface 364 of torque tube 328 and an outer diameter surface 366 of axle 302. Pedestal 362 includes a radially inner surface or foot 368 for engaging the axle 302, a web portion 370 radially outward of foot 368, and a head portion 372 for engaging inner diameter surface 364 of torque tube 328. Pedestal 362 augments support of torque plate barrel 314 within brake assembly 300 generally and, more particularly, against axle 302. Pedestal 362 may be made monolithic with torque tube 328 portion of torque plate barrel 314.

A heat shield 340 is secured directly or indirectly to wheel 304 between a radially inward surface of wheel well 308 and the plurality of torque bars 338. As illustrated in FIG. 3, heat shield 340 is concentric with wheel well 308 and may have a plurality of heat shield sections 342 disposed between respective, adjacent pairs of the plurality of torque bars 338. Heat shield 340, or heat shield sections 342, is spaced from the radially inward surface of wheel well 308 and secured in place by heat shield tabs 390, such that heat shield 340, or heat shield sections 342, is disposed generally parallel to the axis of rotation or central axis 312 of wheel 304 and intermediate the plurality of torque bars 338 and the radially inward surface of wheel well 308. In various embodiments, including for heavy-duty applications, heat shield 340, or heat shield sections 342, may be further secured in place by heat shield carriers 344.

The plurality of torque bars 338 is attached at axially inboard ends to the wheel 304 by torque bar bolts 346. Torque bar bolts 346 extend through respective holes in a flange 350 provided on wheel 304 as shown, which flange 350 for purposes of the present description is intended to be considered as part of wheel well 308. Each of the plurality of torque bars 338 may include a pin 352 or similar member at its axially outboard end (i.e., the end opposite the torque bar bolts 346) that is received within a hole 354 disposed proximate the web portion 310 of the wheel 304. Heat shield 340, or heat shield sections 342, is positioned adjacent a radially inward surface of wheel well 308 and secured in place by heat shield tabs 390.

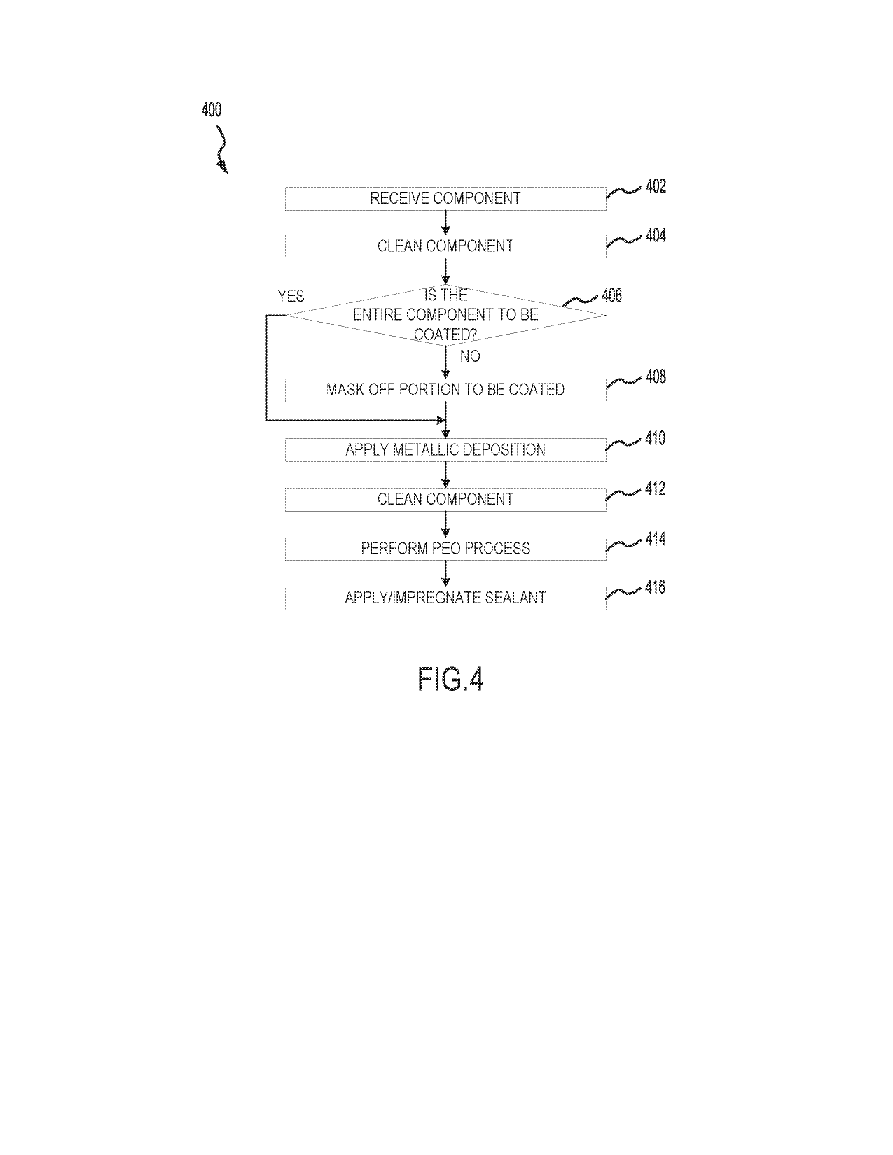

Referring now to FIG. 4, in accordance with various embodiments, a method 400 for converting a surface of an aircraft component to include a hard ceramic coating. In various embodiments, at block 402, the aircraft component, which may be a new or dimensionally restored wheel component or brake component, among others, of at least one a first metal or first metal alloy is received and, at block 404, the component is cleaned in order to receive a metallic deposition of at least one of a second metal or a second metal alloy. In that regard, in various embodiments, the component is cleansed and prepared for optimal adhesion of the at least one of the second metal or the second metal alloy to the surface. At block 406, a decision is made as to whether the entire component is to be coated. In various embodiments, if at block 406 only a portion the component, i.e., a localized repair area, is to be coated, then, at block 408, the remainder of the component is masked. If at block 406 the entire component is to be coated or after masking the remainder of the component at block 408, then, at block 410, the at least one of the second metal or the second metal alloy is applied to the entire component or the portion of the component, i.e., the masked off portion of the component. As described previously, the at least one of the second metal or the second metal alloy may be applied via cold-spraying, metallic plating, or friction stirring, among others. In various embodiments, at block 412, once the at least one of the second metal or the second metal alloy is applied, then the component is cleaned again. In various embodiments, either prior to or after the second cleaning, a surface of the component may be machined to provide a surface that is accepting of the PEO process in order for a desired ceramic coating via the PEO process. Accordingly, in various embodiments the ceramic coating is a combination of oxides of elements within the base metal substrate and those of the electrolyte and thus, the ceramic coating is much harder than the underlying substrate. In various embodiments, at block 414, the component undergoes a PEO process to sufficiently form a wear resistant coating. In various embodiments, at block 416, the component may be sealed with a sealant that penetrates and fills pores within the ceramic coating or may be impregnated with active corrosion inhibitors to protect the ceramic coating from corrosion. In various embodiments, the sealant may be an epoxy-based sealant or a polymer-based sealant, among others.

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to "one embodiment," "an embodiment," "various embodiments," etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 10%, within 5%, within 1%, within 0.1%, or within 0.01% of a stated value. Additionally, the terms “substantially,” “about,” or “approximately” as used herein represent an amount close to the stated amount that still performs a desired function or achieves a desired result. For example, the term “substantially,” “about,” or “approximately” may refer to an amount that is within 10% of, within 5% of, within 1% of, within 0.1% of, and within 0.01% of a stated amount or value.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. An aircraft component, the aircraft component comprising:
a substrate, the substrate comprising at least one a first metal or first metal alloy; and
a ceramic coating formed on a surface of at least a portion of the substrate, wherein the ceramic coating is formed by:
applying at least one of a second metal or a second metal alloy to the surface of the at least the portion of the substrate, the at least one of the second metal or the second metal alloy meeting a predetermined galvanic compatibility with the at least one of the first metal or the first metal alloy; and
subjecting the aircraft component to a plasma electrolytic oxidation (PEO) process, wherein during the PEO process the at least one of the second metal or the second metal alloy on the surface of the at least the portion of the substrate is converted to ceramic.

2. The aircraft component of claim 1, wherein the portion of the substrate includes at least one of a localized repair area or an entire surface of the aircraft component.

3. The aircraft component of claim 1, wherein the aircraft component is at least one of a new component or dimensionally restored component.

4. The aircraft component of claim 1, wherein, prior to applying the at least one of the second metal or the second metal alloy to the surface of the at least the portion of the substrate, the aircraft component is cleaned and prepared for optimal adhesion of the at least one of the second metal or the second metal alloy to the surface.

5. The aircraft component of claim 1, wherein, prior to subjecting the aircraft component to the PEO process, the aircraft component with the at least one of the second metal or the second metal alloy is cleaned.

6. The aircraft component of claim 5, wherein cleaning the aircraft component with the at least one of the second metal or the second metal alloy includes machining the at least one of the second metal or the second metal alloy the surface of the at least the portion of the substrate to a desired surface finishing and wherein the at least the portion of the substrate is a dimensionally restored portion of the aircraft component.

7. The aircraft component of claim 1, wherein the first metal or the first metal alloy is at least one of first aluminum, a first aluminum alloy, first magnesium, a first magnesium alloy, first titanium, or a first titanium alloy and wherein the second metal or the second metal alloy is at least one of second aluminum, a second aluminum alloy, second magnesium, a second magnesium alloy, second titanium, or a second titanium alloy.

8. The aircraft component of claim 1, wherein, after subjecting the aircraft component to the PEO process, at least one of a sealant that penetrates and fills pores within the ceramic coating is applied or the ceramic coating is impregnated with the sealant.

9. A landing gear system of an aircraft, comprising:
at least one aircraft component, the at least one aircraft component comprising:
a substrate, the substrate comprising at least one a first metal or first metal alloy; and
a ceramic coating formed on a surface of at least a portion of the substrate, wherein the ceramic coating is formed by:
applying at least one of a second metal or a second metal alloy to the surface of the at least the portion of the substrate, the at least one of the second metal or the second metal alloy meeting a predetermined galvanic compatibility with the at least one of the first metal or the first metal alloy; and
subjecting the aircraft component to a plasma electrolytic oxidation (PEO) process, wherein during the PEO process the at least one of the second metal or the second metal alloy on the surface of the at least the portion of the substrate is converted to ceramic.

10. The landing gear of claim 9, wherein the portion of the substrate includes at least one of a localized repair area or an entire surface of the aircraft component.

11. The landing gear of claim 9, wherein the aircraft component is at least one of a new component or dimensionally restored component.

12. The landing gear of claim 9, wherein, prior to applying the at least one of the second metal or the second metal alloy to the surface of the at least the portion of the substrate, the aircraft component is cleaned and prepared for optimal adhesion of the at least one of the second metal or the second metal alloy to the surface.

13. The landing gear of claim 9, wherein, prior to subjecting the aircraft component to the PEO process, the aircraft component with the at least one of the second metal or the second metal alloy is cleaned and wherein cleaning the aircraft component with the at least one of the second metal or the second metal alloy includes machining the at least one of the second metal or the second metal alloy the surface of the at least the portion of the substrate to a desired surface finishing and wherein the at least the portion of the substrate is a dimensionally restored portion of the aircraft component.

14. The landing gear of claim 9, wherein the first metal or the first metal alloy is at least one of first aluminum, a first aluminum alloy, first magnesium, a first magnesium alloy, first titanium, or a first titanium alloy and wherein the second metal or the second metal alloy is at least one of second aluminum, a second aluminum alloy, second magnesium, a second magnesium alloy, second titanium, or a second titanium alloy.

15. An aircraft comprising:
a landing gear, wherein the landing gear comprises:
an aircraft component, the aircraft component comprising:
a substrate, the substrate comprising at least one a first metal or first metal alloy; and
a ceramic coating formed on a surface of at least a portion of the substrate, wherein the ceramic coating is formed by:
applying at least one of a second metal or a second metal alloy to the surface of the at least the portion of the substrate, the at least one of the second metal or the second metal alloy that meets a predetermined galvanic compatibility with the at least one of the first metal or the first metal alloy; and
subjecting the aircraft component to a plasma electrolytic oxidation (PEO) process, wherein during the PEO process the at least one of the second metal or the second metal alloy on the surface of the at least the portion of the substrate is converted to ceramic.

16. The aircraft of claim 15, wherein the portion of the substrate includes at least one of a localized repair area or an entire surface of the aircraft component.

17. The aircraft of claim 15, wherein the aircraft component is at least one of a new component or dimensionally restored component.

18. The aircraft of claim 15, wherein, prior to applying the at least one of the second metal or the second metal alloy to the surface of the at least the portion of the substrate, the aircraft component is cleaned and prepared for optimal adhesion of the at least one of the second metal or the second metal alloy to the surface.

19. The aircraft of claim 15, wherein, prior to subjecting the aircraft component to the PEO process, the aircraft component with the at least one of the second metal or the second metal alloy is cleaned and wherein cleaning the aircraft component with the at least one of the second metal or the second metal alloy includes machining the at least one of the second metal or the second metal alloy the surface of the at least the portion of the substrate to a desired surface finishing and wherein the at least the portion of the substrate is a dimensionally restored portion of the aircraft component.

20. The aircraft of claim 15, wherein the first metal or the first metal alloy is at least one of first aluminum, a first aluminum alloy, first magnesium, a first magnesium alloy, first titanium, or a first titanium alloy and wherein the second metal or the second metal alloy is at least one of second aluminum, a second aluminum alloy, second magnesium, a second magnesium alloy, second titanium, or a second titanium alloy.
